(19) United States
(12) Patent Application Publication
(10) Pub. No.: US 2004/0019137 A1
(43) Pub. Date: Jan. 29, 2004

(54) Stabilising composition for halogenated polymers comprising a unsaturated heterocyclic compound

(76) Inventor: Dominique Hebrault, Lyon (FR)

Correspondence Address: Jean Louis Seugnet, Intellectual Property Department, Rhodia Inc CN 7500, 259 Prospect Plains Road, Cranbury, NJ, 08512-7500, US

(21) Appl. No.: 10/333,080

(22) PCT Filed: Jul. 11, 2001
(86) PCT No.: PCT/FR01/02242

(30) Foreign Application Priority Data
Jul. 17, 2000 (FR) 00/09311

(51) Int. Cl. C08K 5/35

(52) U.S. Cl. 524/95

(57) ABSTRACT

The invention concerns a stabilising composition for halogenated polymer comprising at least a compound of formulae (I) and/or (II), wherein: X, Y, Z, identical or different, represent an oxygen atom, a nitrogen atom, a sulphur atom, or a phosphorus atom; R1 represents a radical comprising 1 to 20 carbon atoms; R2 represents a hydrogen atom, a radical comprising 1 to 20 carbon atoms, a —COR radical; R1 and R2 are optionally mutually bound so as to form a cycle; R3 and R4, identical or different, represent a hydrogen atom, a radical comprising 1 to 20 carbon atoms; n=1 depending on the valence of X, m=0 to 2 depending on the valence of Y; p=0 to 2 depending on the valence of Z; q is an integer between 1 and 10, preferably between 1 and 4.

The subject of the present invention is a stabilizing composition for halogenated polymer comprising one or more compounds with at least one ethylenic unsaturation (C═C) and at least one heterocycle.

Halogenated polymers, and in particular chlorinated polymers, require the use of stabilizing additives which act during the shaping of the polymers, or else after the shaping of the latter (ageing). These polymers are sensitive to heat and to light. The sensitivity to heat is shown by a degradation of the coloration of the piece of polymer, which changes from a light initial colour (white to light yellow) to chestnut, then to black.

Numerous additives have been developed to date with the aim of stabilizing halogenated polymers. Thus, it is known to use carboxylates of alkaline-earth metals (calcium) and/or transition metals (zinc), compounds of organotin type, or else lead-based compounds. These additives have also been used in combination with other compounds such as for example organic compounds of the type of β-diketones or β-ketoesters, phosphites, etc., or else mineral compounds such as hydrotalcites, etc.

One of the objectives of the present invention is to propose a stabilizing composition for halogenated polymers, comprising novel compounds.

Another object of the invention is to propose a means of stabilizing halogenated polymers which does not use additives comprising metals, or of a lower content than that customarily used in the field.

Thus, the subject of the present invention is a stabilizing composition for halogenated polymer comprising at least one compound of the following formula (I) or (II):

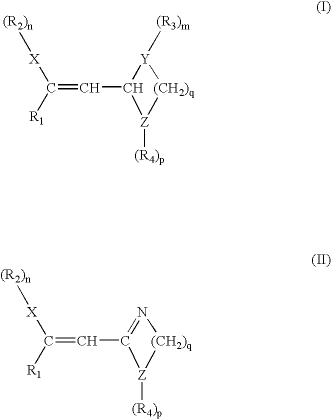

Formulae in which:

X, Y, Z, identical or non-identical, represent an oxygen atom, a nitrogen atom, a sulphur atom, or a phosphorus atom;

R₁ represents a radical comprising 1 to 20 carbon atoms of alkyl type; alkenyl carrying one or more conjugated or non-conjugated ethylenic unsaturations; cyclic carrying one or more conjugated or non-conjugated ethylenic unsaturations; aromatic optionally substituted;

R₂ represents a hydrogen atom; a radical comprising 1 to 20 carbon atoms, of alkyl type; alkenyl carrying one or more conjugated or non-conjugated ethylenic unsaturations; cyclic carrying one or more conjugated or non-conjugated ethylenic unsaturations; aromatic, substituted or non-substituted, optionally condensed with an aromatic or non-aromatic cycle; a —COR radical with R representing an alkyl radical comprising 1 to 20 carbon atoms;

R₁ and R₂ are optionally interlinked so as to form a cycle optionally carrying one or more ethylenic unsaturations, conjugated or non-conjugated;

R₃ and R₄, identical or non-identical, represent a hydrogen atom; a radical comprising 1 to 20 carbon atoms of alkyl type; alkenyl, carrying one or more conjugated or non-conjugated ethylenic unsaturations; cyclic optionally carrying one or more conjugated or non-conjugated ethylenic unsaturations;

aromatic optionally substituted;

the said radicals R₁, R₂, R₃ and R₄, being optionally interrupted by one or more —O—, —S—, —CO—, —NR—, —NRCO— groups, and/or optionally carrying at least one —OH, —OR, —R′OH group, with R and R′ representing a hydrogen atom or an alkyl radical comprising 1 to 20 carbon atoms;

at least one of the radicals R₂ or R₃ being a hydrogen atom;

n=1 to 3 according to the valence of X;

m=0 to 2 according to the valence of Y;

p=0 to 2 according to the valence of Z;

q is an integer between 1 and 10, preferably between 1 and 4.

More particularly, the radical R₁ is an alkyl radical comprising 1 to 20 carbon atoms, preferably 1 to 10 carbon atoms, optionally carrying at least one —OH, —OR, —R′OH group, with R representing a monovalent alkyl radical comprising 1 to 20 carbon atoms, and R′ representing a divalent alkyl radical comprising 1 to 20 carbon atoms.

As examples of such radicals, there can be mentioned methyl, ethyl, propyl, isopropyl, butyl and its isomers, hydromethyl, hydroxyethyl.

According to an advantageous embodiment of the present invention, the compounds of formula (I) and/or (II) are such that the coefficient q=2 or 3.

A first family of compounds is constituted by those of formula (I). More particularly, within the framework of this first family, a type of advantageous compounds is represented by those in which X and Y, identical or non-identical, represent nitrogen or sulphur, and preferably nitrogen.

According to this variant, Z preferably represents oxygen or nitrogen.

Furthermore, according to the valence of Y, m=0 or 1. Thus, if Y represents sulphur, m=0. In addition, if Y represents nitrogen, m=1 and R₃ preferably represents hydrogen.

Also according to this particular variant, R₂ preferably represents an aromatic radical comprising 4 to 6 carbon atoms optionally condensed with an aromatic radical comprising 6 carbon atoms, a —COR radical with R representing an alkyl radical comprising 1 to 20 carbon atoms, preferably 1 to 10 carbon atoms, or an alkyl radical comprising 1 to 20 carbon atoms, preferably 1 to 10 carbon atoms, optionally interrupted by an —O— or —S— group.

It is to be noted that if X represents nitrogen, R₂ can be an aromatic cyclic radical including or not including the nitrogen atom. In this last possibility, the X atom is itself part of the pyrrole or indole radical, if R2 is condensed with an aromatic cycle.

Another variant within the framework of the first family of compounds, corresponding to those of formula (I), is constituted by compounds in which X represents sulphur and Y and Z represent oxygen.

More particularly, the radical R₂ represents hydrogen.

These compounds can be obtained by any means known by a person skilled in the art.

An example of synthesis of a compound of formula (I) will now be explained, in which X represents sulphur, Y and Z, identical or non-identical, represent an oxygen or nitrogen atom, and R₁ an alkyl radical.

In a first stage, an unsaturated α,β aldehyde, such as for example aminocrotonate, is reacted with hydrogen sulphide.

The reaction is carried out by introducing the aldehyde into a solvent, chosen in particular from the chlorinated solvents (chloroform), saturated in hydrogen sulphide. The said solvent can also comprise a tertiary amine.

It is to be noted that during the introduction of the aldehyde, the reaction medium is maintained under a flux of hydrogen sulphide.

In addition, the introduction of the aldehyde is preferably carried out dropwise.

The introduction period is generally between 2 and 10 hours.

This first stage is carried out at a temperature lower than 0° C., and more particularly of the order of −20° C. to −10° C.

Once the aldehyde has been added, the reaction medium is preserved under agitation at a temperature of the order of −25° C.

At the end of the reaction, a strong acid, for example, hydrochloric acid, is added and the reaction medium is agitated.

The reaction product is separated by conventional means.

A second stage involves reacting the compound derived from the preceding stage, with a compound of formula HO—(CH₂)q-OH (for example ethylene glycol) or with HO—(CH₂)q-NH₂ (for example ethanolamine), or else with H₂N—(CH₂)q-NH₂ (for example ethylenediamine), in the presence of a catalyst such as in particular paratoluene sulphonic acid.

Customarily, the molar ratio of the compound derived from the preceding stage and from the glycol is around 1/2.

The reaction preferably takes place in the presence of a solvent, such as for example toluene.

The reaction temperature is close to the reflux of the solvent used.

The product is then separated by conventional methods.

In a third stage, the acetal obtained is reacted with a chlorinating agent such as for example N-chlorosuccinimide.

The operation can take place in the presence of a chlorinated solvent.

The reaction can be advantageously carried out at a temperature close to the ambient temperature.

Finally, the resulting product, once the solvent is eliminated, is placed in contact with a solution of an alkaline metal alcoholate, preferably potassium tert-butylate, in anhydrous medium.

The solvent used is preferably an ether such as tetrahydrofuran.

A 50 to 100% molar excess of alcoholate is preferably used relative to the product.

The contact and the reaction are preferably carried out at a temperature lower than the ambient temperature, more particularly lower than 10° C., preferably of the order of 0° C.

The resulting product, corresponding to the compound of formula (I) as described above, is isolated in conventional manner.

It is specified that the resulting compound can undergo a dehydrogenation stage if one or both heteroatoms of the cycle are nitrogen atoms. This stage enables a compound of formula (II) to result.

The dehydrogenation can in particular take place by using a thermal treatment in the presence of a catalyst chosen for example from manganese oxide, or tert-butyl hydroperoxide combined with a ruthenium salt.

As an example of synthesis of a compound of formula (II), there can be mentioned that which allows a compound to be obtained for which X represents a nitrogen atom, Z represents an oxygen or nitrogen atom, R₁ an alkyl radical.

Thus, in a first stage, on the one hand an unsaturated α,β ester (such as for example an alkyl aminocrotonate, the alkyl part comprising more particularly 1 to 4 carbon atoms) is reacted with, on the other hand, an aminoalcohol of formula HO—(CH₂)q-NH₂ or else with a diamine of formula H₂N—(CH₂)q-NH₂.

The reaction is customarily carried out under agitation and at a temperature in general between 150 and 250° C.

Advantageously, the molar ratio of the ester to the aminoalcohol or the diamine is between approximately 0.5 and 1.2.

This reaction can be carried out in the presence of a suitable solvent. The solvent is more particularly chosen from those of which the boiling point is higher than that of the alcohol eliminated in the course of the reaction. For example, chlorobenzene is an example of a suitable solvent. But advantageously, the solvent is not necessary.

The compound obtained is then placed in conditions such that the cycle is formed. Such conditions can be achieved for example in the presence of thionyl chloride. It is to be noted that according to the nature of the atoms, an agent which aids cyclization is not necessary.

The reaction is again carried out under agitation.

The temperature is customarily between 50 and 80° C., in the presence of compounds such as thionyl chloride. If this type of compound is not used, the temperature is then customarily between 150-250° C.

Finally, this reaction too can be carried out in the presence of a suitable solvent such as for example alkylated or aromatic chlorinated solvents, aromatic solvents, such as in particular toluene, xylene. But preferably no solvent is used.

As indicated above, the compounds which have just been described are used in stabilizing compositions for halogenated polymers.

By halogenated polymer included in the composition according to the invention, it is meant more particularly chlorinated polymers such as polyvinyl chloride (PVC).

In general, any type of PVC is suitable, regardless of its method of preparation: mass, suspension or emulsion polymerization or any other type and regardless of its intrinsic viscosity.

Homopolymers of vinyl chloride can also be chemically modified, for example by chlorination.

Numerous copolymers of vinyl chloride can also be stabilized against the effects of heat, that is to say yellowing and degradation.

These are in particular the copolymers obtained by copolymerization of vinyl chloride with other monomers having a polymerizable ethylenic bond, such as for example vinyl acetate or vinylidene chloride; maleic, fumaric acids and/or their esters; olefins such as ethylene, propylene, hexene; acrylic or methacrylic esters; styrene; vinyl ethers such as vinyl dodecyl ether.

Customarily, these copolymers contain at least 50% by weight of vinyl chloride units and preferably at least 80% by weight of vinyl chloride units.

The compositions which are able to be stabilized according to the procedure of the invention can also contain mixtures based on chlorinated polymer containing minority quantities of other polymers, such as halogenated polyolefins or acrylonitrile/butadiene/styrene copolymers.

PVC alone or mixed with other polymers is the chlorinated polymer most widely used in the invention.

When the composition according to the invention is used for stabilizing halogenated polymer(s), the total content of compounds (I) and/or (II) used is more particularly between 0.005 and 5% by weight relative to the weight of halogenated polymer(s), preferably between 0.5 and 5% by weight relative to the weight of halogenated polymer(s).

The formulations comprising the halogenated polymer can be rigid formulations, that is to say without a plasticizer, or semi-rigid, that is to say with reduced plasticizer contents, such as for applications in building, the manufacture of various sections or electric cables, or else formulations which contain only additives approved for contact with food, for the manufacture of bottles.

Most often these formulations contain an impact-reinforcing agent, such as a methacrylate/butadiene/styrene copolymer for example.

They can also be plasticized formulations such as for the manufacture of films for agricultural use.

The formulations of halogenated polymers comprising the stabilizing composition according to the invention can also contain stabilizing additives which are conventional in the field, be they of mineral or organic nature.

As an example of a stabilizer of mineral type, there can be mentioned sulphates, and/or carbonates, of aluminium and/or magnesium, of hydrotalcite type in particular. It will be recalled that the compounds of hydrotalcite type correspond to the following formula: Mg₁₋ₓAlₓ(OH)₂Aⁿ⁻_{x/n}.mH₂O, in which x is between 0 exclusive and 0.5, Aⁿ⁻ represents an anion such as carbonate in particular, n varies from 1 to 3 and m is positive. It is to be noted that products of this type can be used which have undergone a surface treatment with an organic compound. Furthermore, it would not be outside the context of the present invention to use a product of hydrotalcite type doped with zinc, which has optionally undergone a surface treatment with an organic compound. Among the products of this type, there can be mentioned quite particularly Alcamizero® 4 (commercially available from Kyowa).

Essentially amorphous compounds of formula (MgO)_{y}, Al₂O₃, (CO₂)ₓ, (H₂O)_{z} in which x, y and z verify the following inequations: 0<x≦0.7; 0<y≦1.7 and z≧3 can also be used. These compounds are described in particular in the patent application EP 509 864. Moreover, the compounds called katoite of formula Ca₃Al₂(OH)₁₂ or else Ca₃Al₂(SiO)₄(OH)₁₂ can also be used.

If it is present, the quantity of this type of compound can vary between 0.05 and 2 g per 100 g of halogenated polymer.

As stabilizers of organic type, there can also be cited polyols containing 2 to 32 carbon atoms and having 2 to 9 hydroxyl groups.

Among these compounds, there can be mentioned C₃-C₃₀ diols such as propylene glycol, butanediol, hexanediol, dodecanediol, neopentyl glycol, polyols such as trimethylol propane, pentaerythritol, dipentaerythritol, tripentaerythritol, xylitol, mannitol, sorbitol, glycerol, mixtures of glycerol oligomers having a degree of polymerization of 2 to 10.

Another family of polyols which can appropriately be used is constituted by partly acetylated polyvinyl alcohols.

Hydroxylated compounds containing isocyanurate groups, alone or combined with the above-mentioned polyols, such as for example tris(2-hydroxyethyl)isocyanurate, can also be used.

If they are present, the quantity of polyol and/or hydroxylated compound used is in general between 0.05 and 5 g per 100 g of halogenated polymer. More particularly, it is less than 2 g per 100 g of halogenated polymer.

There can optionally be incorporated into the formulation comprising the halogenated polymer(s) compounds of organic phosphite type such as for example trialkyl, aryl, triaryl, dialkylaryl or diarylalkyl phosphites for which the term alkyl designates the hydrocarbonated groups of C₈-C₂₂ monoalcohols or polyols, and the term aryl designates the aromatic groups of phenol or phenol substituted by C₆-C₁₂ alkyl groups. Calcium phosphites such as for example compounds of Ca(HPO₃).(H₂O) type as well as phosphite-hydroxy-aluminium-calcium complexes can also be used.

The quantity of additive of this type, if used, is customarily between 0.1 and 2 g per 100 g of halogenated polymer.

It is also conceivable to use at least one synthetic, crystalline, alkali metal aluminosilicate, having a water content between 13 and 25% by weight, of the composition 0.7-1M₂O.Al₂O₃.1.3-2.4SiO₂ in which M represents an alkali metal such as in particular sodium. Zeolites of NaA type as described in the U.S. Pat. No. 4,590,233 in particular are suitable.

When it is used, the quantity of this type of compound generally varies between 0.1 and 5 g per 100 g halogenated polymer.

Compounds of the type of epoxides can also be employed. These compounds are generally chosen from epoxidized polyglycerides or epoxidized fatty acid esters such as epoxidized linseed, soya or fish oils.

The quantity of these compounds, if they are present, customarily varies between 0.5 and 10 g per 100 g of halogenated polymer.

Finally, among the conventional additives in this field, there can be mentioned titanium dioxide. Preferably, the titanium dioxide is in rutile form.

In general, the granulometry of the titanium dioxide included in the compositions according to the invention is between 0.1 and 0.5 μm.

According to a particular embodiment of the invention, titanium dioxide in rutile form is used having undergone a surface treatment, preferably mineral, such as the titanium dioxides Rhoditane® RL18, Rhoditan® RL20, Rhoditan® RL90, commercially available from Rhodia Chimie, the titanium dioxides Kronos 2081® and 2220® commercially available from Kronos.

Formulations based on halogenated polymers can contain other white or coloured pigments. Among the pigments chosen, there can be mentioned in particular cerium sulphide.

It is to be noted that the quantity of pigment introduced into the formulation varies within a wide range and depends in particular on the colouring power of the pigment and on the final coloration desired. However, by way of example and if the polymeric composition contains it, the quantity of pigment can vary from 0.1 to 20 g per 100 g of halogenated polymer, preferably from 0.5 to 15 g relative to the same reference.

Additives such as phenolic antioxidants, anti-UV agents such as 2-hydroxybenzophenones, 2-hydroxybenzotriazoles or sterically hindered amines, customarily known under the term Hals, can be included in the halogenated polymer composition.

The quantity of this type of additive generally varies between 0.05 and 3 g per 100 g of halogenated polymer.

If necessary, lubricants can also be used which will facilitate implementation, chosen in particular from glycerol monostearates or else propylene glycol, fatty acids or their esters, montan waxes, polyethylene waxes or their oxidized derivatives, paraffins, metallic soaps, functionalized polymethylsiloxane oils such as for example γ-hydroxypropylenated oils.

The quantity of lubricants included in the formulation based on halogenated polymer varies in general between 0.05 and 2 g per 100 g halogenated polymer.

The formulation can also comprise plasticizers chosen from alkyl phthalates. The compounds most generally used are chosen from di(ethyl-2-hexyl) phthalate, C₆-C₁₂ linear diacid esters, trimellitates or also phosphate esters.

The quantity of plasticizing agent employed in the formulations varies to a large degree according to the rigid or flexible nature of the final polymer. As an indication, the content varies from 0 to 100 g per 100 g of polymer.

As indicated above, the use of the composition according to the invention does not require the use of stabilizers of metallic type, or in smaller amounts than those customarily used.

Thus, as an example of metallic stabilizers, there can be mentioned compounds comprising an alkaline-earth metal or a metal chosen from columns IIB, IIA, IVB of the periodic table of elements (published in the supplement to the Bulletin de la Société Chimique de France, No. 1, January 1966).

The metals are more particularly chosen from calcium, barium, magnesium, strontium, zinc, cadmium, tin or also lead.

It is to be noted that combinations are conceivable such as for example mixtures based on calcium and zinc, barium and zinc, barium and cadmium, the first combination being preferred.

As regards the compounds of organic type containing at least one of the elements of columns IIB and IIA, there can be mentioned quite particularly salts of organic acids such as aliphatic, aromatic carboxylated acids or fatty acids, or also phenolates or aromatic alcoholates.

The most commonly used are for example the salts of the elements IIA or IIB of maleic, acetic, diacetic, propionic, hexanoic, ethyl-2 hexanoic, decanoic, undecanoic, lauric, myristic, palmitic, stearic, oleic ricinoleic, behenic (docosanoic), hydroxystearic, hydroxyundecanoic, benzoic, phenylacetic, para-tert-butylbenzoic and salicylic acids, phenolates, alcoholates derived from napththol or phenols substituted by one or more alkyl radicals, such as nonylphenols.

As regards compounds of organic type containing lead, there can be mentioned in particular dibasic lead carbonate, tribasic lead sulphate, tetrabasic lead sulphate, dibasic lead phosphite, lead orthosilicate, basic lead silicate, coprecipitate of lead silicate and sulphate, basic lead chlorosilicate, coprecipitate of silica gel and lead orthosilicate, dibasic lead phthalate, neutral lead stearate, dibasic lead stearate, tetrabasic lead fumarate, dibasic lead maleate, lead 2-ethyl hexanoate, lead laurate (see in particular ENCYCLOPAEDIA OF PVC by Leonard I. Nass (1976) pp 299-303).

As regards tin-based compounds, there can be mentioned in particular mono- or dialkyltin carboxylates and mono- or dialkyltin mercaptides; but also more commonly derivatives of di-n-methyltin, di-n-butyltin or di-n-octyltin such as for example dibutyltin dilaurate, dibutyltin maleate, dibutyltin laurate-maleate, dibutyltin bis(mono-C₄-C₈ alkyl maleate), dibutyltin bis(lauryl-mercaptide), dibutyltin S-S′(isooctyl mercaptoacetate), dibutyltin β-mercapto propionate, di-n-octyltin polymer maleate, di-n-octyltin bis-S-S′(isooctyl mercaptoacetate), di-n-octyltin β-mercaptopropionate. Monoalkylated derivatives of the compounds mentioned above are also suitable (see also the publication “PLASTICS ADDITIVES HANDBOOK” by GACHTER/MULLER (1985) pp 204-210 or in ENCYLOPAEDIA OF PVC by Leonard I. NASS (1976) pp 313-325).

Thus the quantity of metallic stabilizers can vary between 0 and 100 ppm, expressed relative to the metal, per 100 g of halogenated polymer. More particularly, this quantity can be between 0 and 50 ppm per 100 g of halogenated polymer.

The preparation of the formulation based on halogenated polymer can be carried out by any means known by a person skilled in the art.

Thus, the stabilizing compositions, the conventional additives in the field, can be incorporated into the polymer individually or indeed after having previously prepared a mixture of several of these constituents.

The conventional incorporation methods are thoroughly suitable for obtaining the PVC-based formulation.

Thus, and only by way of example, this operation can be carried out in a mixer provided with a system of blades and counter-blades operating at high speed.

In general, the mixing operation is carried out at a temperature less than 130° C.

Once the mixture has been produced, the composition is shaped according to the conventional methods in the field such as injection, extrusion blow-moulding, extrusion, calendering or also rotational moulding.

The temperature at which the shaping is carried out varies in general from 150 to 220° C.

1. Stabilizing composition for halogenated polymer comprising at least one compound of the following formulae (I) and/or (II): 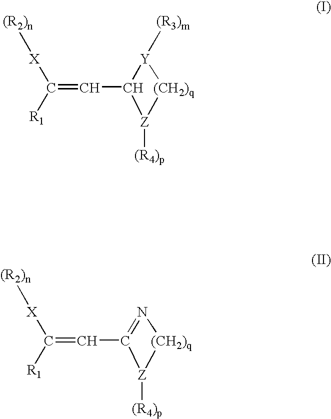
Formulae in which:
X, Y, Z, identical or not, represent an oxygen atom, a nitrogen atom, a sulphur atom, or a phosphorus atom;
R₁ represents a radical comprising 1 to 20 carbon atoms of alkyl type; alkenyl carrying one or more conjugated or non-conjugated ethylenic unsaturations; cyclic carrying one or more conjugated or non-conjugated ethylenic unsaturations; aromatic optionally substituted;
R₂ represents a hydrogen atom, a radical comprising 1 to 20 carbon atoms, of alkyl type; alkenyl carrying one or more conjugated or non-conjugated ethylenic unsaturations; cyclic carrying one or more conjugated or non-conjugated ethylenic unsaturations; aromatic, substituted or non-substituted, optionally condensed with an aromatic or non-aromatic cycle; a —COR radical with R representing an alkyl radical comprising 1 to 20 carbon atoms;
R₁ and R₂ are optionally interlinked so as to form a cycle optionally carrying one or more ethylenic unsaturations, conjugated or non-conjugated;
R₃ and R₄, identical or non-identical, represent a hydrogen atom; a radical comprising 1 to 20 carbon atoms of alkyl type; alkenyl carrying one or more conjugated or non-conjugated ethylenic unsaturations; cyclic optionally carrying one or more conjugated or non-conjugated ethylenic unsaturations;
aromatic optionally substituted;
the said radicals R₁, R₂, R₃ and R₄, being optionally interrupted by one or more —O—, —S—, —CO—, —NR—, —NRCO— groups, and/or optionally carrying at least one —OH, —OR, R′OH group, with R and R′ representing a hydrogen atom or an alkyl radical comprising 1 to 20 carbon atoms;
at least one of the R₂ or R₃ radicals being a hydrogen atom;
n=1 to 3 according to the valence of X;
m=0 to 2 according to the valence of Y;
p=0 to 2 according to the valence of Z;
q is an integer between 1 and 10, preferably between 1 and 4.

2. Composition according to the preceding claim, characterized in that the radical R₁ is an alkyl radical comprising 1 to 20 carbon atoms, preferably 1 to 10 carbon atoms, optionally carrying at least one —OH, —OR, —R′OH group, with R representing a monovalent alkyl radical comprising 1 to 20 carbon atoms and R′ representing a divalent alkyl radical comprising 1 to 20 carbon atoms.

3. Composition according to one of the preceding claims, characterized in that q=2 or 3.

4. Composition according to one of the preceding claims, characterized in that, in the formula (I), X represents nitrogen or sulphur.

5. Composition according to the preceding claim, characterized in that Y and Z, identical or non-identical, represent nitrogen or sulphur.

6. Composition according to any one of the preceding claims 4 or 5, characterized in that:
*according to the valence of Y, m=0 or R₃ represents hydrogen, and
*R₂ represents an aromatic cyclic radical comprising 4 to 6 carbon atoms, including or not including the Y atom, the said aromatic cyclic radical being optionally condensed with an aromatic radical comprising 6 carbon atoms; a —COR formula radical in which R represents an alkyl radical comprising 1 to 20 carbon atoms, preferably 1 to 10 carbon atoms, or an alkyl radical comprising 1 to 20 carbon atoms, preferably 1 to 10 carbon atoms, optionally interrupted by an —O— or —S— group.

7. Composition according to any one of claims 1 to 4, characterized in that X represents sulphur and Y and Z represent oxygen.

8. Composition according to any one of claims 1 to 3, characterized in that in the formula (II) X represents nitrogen and Z represents oxygen or sulphur.

9. Use of the composition according to one of the preceding claims for stabilizing halogenated polymer(s), in which the total quantity of compounds (I) and/or (II) is more particularly between 0.005 and 5% by weight relative to the weight of halogenated polymer(s), preferably between 0.5 and 5% by weight relative to the weight of halogenated polymer(s).
